(19) United States
(12) Patent Application Publication
(10) Pub. No.: US 2024/0052651 A1
(43) Pub. Date: Feb. 15, 2024

(54) FRAME FOR CARRYING A CONCRETE-DISTRIBUTION BOOM

(71) Applicant: Putzmeister Engineering GmbH, Aichtal (DE)

(72) Inventors: Dietmar Fügel, Aichtal (DE); Benedikt Pawisa, Aichtal (DE); Werner Schneider, Aichtal (DE)

(21) Appl. No.: 18/258,079

(22) PCT Filed: Nov. 19, 2021
(86) PCT No.: PCT/EP2021/082259

§ 371 Date: Jun. 16, 2023

(30) Foreign Application Priority Data
Dec. 17, 2020 (DE) 10 2020 134 012.5

(51) Int. Cl. E04G 21/04

(52) U.S. Cl. CPC E04G 21/0445

(57) ABSTRACT

The present invention relates to a frame for carrying a concrete-distribution boom, the frame comprising a carrier profile (13) which has: at least one force-absorption region (16, 17), for absorbing a flow of force exerted by the concrete-distribution boom; and a force-dissipation region (18), which is spaced apart in the longitudinal direction of the carrier profile (13), for dissipating the flow of force into the ground. The carrier profile (13) comprises at least two profiled sheets (20, 21), which are each bent along at least one bending axis (26, 27, 31) and are assembled along at least two connection lines (22, 23) to form a hollow profile. The carrier profile formed by bent profiled sheets is simple to produce and flexible to use.

### BACKGROUND

The present invention relates to a frame for carrying a concrete-distribution boom.

For discharging concrete by means of mobile or stationary concrete pumps, use is regularly made of a concrete-distribution boom which is carried by a frame. For this purpose, what is known as a boom pedestal is usually fixed to the frame and the concrete distributer is mounted on the boom pedestal so as to be rotatable about a vertical axis. In addition, the concrete-distribution boom can be constructed from a plurality of boom segments which are designed to be pivotable relative to one another in order to reach a desired discharge location. The concrete, which is pressurized by a pumping device, can be discharged at a desired location via a concrete delivery line guided along the concrete-distribution boom.

In particular in an extended state of the boom segments, large load torques arise which have to be introduced into the frame and dissipated therefrom into the ground. For this purpose, the frame usually has two carrier profiles which are oriented in longitudinal direction of the frame and which serve to transmit a flow of force.

It is known in principle in the prior art to use a frame with carrier profiles which consist of a closed square tube frame produced by an extrusion process. Such square tube frames have a high degree of stiffness and stability. However, a disadvantage with the closed square tube frames is that they are complicated to produce and inflexible.

### SUMMARY

Against this background, it is the object of the present invention to provide a frame for carrying a concrete-distribution boom and a concrete pump having such a frame that at least partially avoids the aforementioned disadvantages. This object is achieved by the features of the independent claims. Advantageous embodiments are specified in the dependent claims.

The frame according to the invention for carrying a concrete-distribution boom comprises a carrier profile which has at least one force-absorption region for absorbing a flow of force exerted by the concrete-distribution boom, and a force-dissipation region, which is spaced apart in the longitudinal direction of the carrier profile, for dissipating the flow of force into the ground. The carrier profile comprises at least two profiled sheets which are each bent along at least one bending axis and are assembled along at least two connection lines to form a hollow profile.

First of all, some of the terms used within the context of the present description will be explained. The frame according to the invention has at least one and preferably two carrier profiles which, for example, can be oriented parallel to one another. For the sake of simplicity, within the context of the present description, only the configuration of a single carrier profile will be explained at many points. It will be understood that the frame according to the invention can also have two or more carrier profiles which can also have the features explained within the context of the present description. The carrier profile customarily has a longitudinal direction, along which the flow of force is channeled from the force-absorption region to the force-dissipation region. This longitudinal direction can correspond to the longitudinal direction of the frame. The frame can in particular have a boom pedestal which serves for connecting the concrete-distribution boom. The boom pedestal is customarily fixedly connected to the carrier profile in the force-absorption region of the carrier profile and is preferably designed for rotatably mounting the concrete-distribution boom about a vertical axis. The frame can furthermore have a supporting system which is connected to the carrier profile in the force-dissipation region and which is designed to introduce the flow of force transmitted by the carrier profile into the ground.

There can be provision that a substantial part (for example more than 10%, more than 20% or more than 30%) of the flow of force is transmitted from the force-absorption region along the carrier profile (or, where appropriate, along the carrier profiles) to the force-dissipation region. The frame differs in this respect from supporting constructions in which the flow of force is introduced from the boom pedestal directly into a supporting structure formed by support leg boxes and into extendible or outwardly pivotable support legs which are connected thereto (see, for instance, EP 3 369 876 A1). In the case of the present frame, rear support legs are not absolutely necessary, since the carrier profile together with a supporting system fastened thereto already performs a corresponding rearward supporting function. Since rearward support legs take up a large amount of space during use after being extended or pivoted out, the space requirement of the present frame is correspondingly reduced. Moreover, more loading area is available on the frame owing to the absence of rear support legs.

Within the context of the invention, it has been recognized that the bent profiled sheets allow the production of a cost-effective carrier profile which is reliable and flexible in use. In particular, it has been shown that the assembly along two connection lines, at which the profiled sheets can, for example, be screwed or welded to one another, results in a stable carrier profile with low distortion. Moreover, through a suitable choice of the bending axes and bending angles, the cross-sectional shape of the carrier profiles can be adapted in a considerably simpler manner by comparison with previously known square tube frames whose shape is predetermined by the extrusion process.

Carrier profiles of a frame are regularly also used to fasten attachment parts thereto. The attachment parts may be, for example, platform holders, parts of the supporting system, holding devices for the pumping device, for lines or for a water tank, a connecting strut for connecting the boom pedestal to the carrier profile and/or parts of the boom support pedestal. In a preferred embodiment, at least one of the profiled sheets therefore has a fastening opening for fixing an attachment part to the carrier profile. The fastening opening can form a passage to an inner region of the hollow profile. By contrast, in the case of square tube frames known from the prior art and produced by an extrusion process, the subsequent production of fastening openings is extremely complicated, with the result that attachment parts are customarily fastened by means of welded connections. This entails high costs and leads to a low degree of flexibility. On the contrary, the fastening openings prefabricated at desired positions in the carrier profile of the presently described frame allow flexible and releasable mounting of attachment parts. Moreover, it is easily possible for the profiled sheets, before being assembled to form the hollow profile and preferably also before bending of the profiled sheets, to be provided with a desired number of fastening openings and for the profiled sheets to be bent only in a subsequent step and assembled to form the hollow profile. Furthermore, the releasability of the attachment parts allows clearances to be created which make it possible to repair and maintain components which would otherwise be blocked by the attachment parts.

Finally, it has been shown that any weakening of the stability of the carrier profile caused by the fastening openings can be compensated for in a simple manner by a corresponding (larger) dimensioning of the hollow profile or of the profiled sheets. In particular, with a suitable choice of the bending axes and bending angles, it is possible within the context of the invention in a simple manner to better utilize an existing installation space and thereby increase the stability of the carrier profile.

An access opening can be provided adjacent to a fastening opening. In this way, simple access is possible to a fastening means which can be used for fixing an attachment part in the fastening opening. This applies in particular if the fastening opening forms a passage to an inner region of the hollow profile. The fastening openings can have an area of more than 0.3 cm². The area of the fastening openings can lie, for example, in a range between 0.3 cm² and 20 cm², preferably between 0.5 cm² and 10 cm² and further preferably between 0.8 cm² and 2 cm². Access openings can have an area which is greater than 100 cm². For example, the area of the access openings can lie between 100 cm² and 500 cm², preferably between 120 cm² and 400 cm², further preferably between 140 cm² and 300 cm².

In one embodiment, the connection lines can be oriented parallel to the longitudinal direction of the carrier profile. In this case, the flow of force is channeled along the connection lines, as a result of which the loading of the connection is reduced and the stiffness of the hollow profiles is increased.

In one embodiment, the bending axes are oriented parallel to the longitudinal direction of the carrier profile. The stiffness of the hollow profiles can also be improved by this measure, since the flow of force runs along the bending axes.

The profiled sheets can be joined together along the connection lines to form the hollow profile. The joining connection can be, for example, a welded connection. Alternatively, however, other joining connections, for example an adhesive connection, also come into consideration. The use of a welded connection leads to very stable and torsion-resistant hollow profiles. It has also been shown that a welding distortion occurring during welding as a result of the action of heat is extremely small since each profiled sheet, as viewed in cross section, is welded at two opposite ends to the respectively adjoining profiled sheet. A material distortion caused by the welding is thereby virtually eliminated.

In particular, the hollow profile can be composed of two profiled sheets. In this case, the profiled sheets can, as viewed in cross section, be subdivided by the bending axes into subportions. Outside subportions of a profiled sheet can assume an angle with one another of between 75° and 105°, preferably between 85° and 95° and further preferably an angle of substantially 90°. Moreover, in the region of the connection line, an outside profiled sheet portion of one of the profiled sheets can assume an angle with an adjoining outside profiled sheet portion of the other of the profiled sheets of between 75° and 105°, preferably between 85° and 95° and further preferably an angle of substantially 90°. In one embodiment, the hollow profile additionally has a maximum cross-sectional width and maximum cross-sectional height, wherein the connection lines lie diagonally opposite one another in an imaginary rectangle formed by the maximum cross-sectional width and the maximum cross-sectional height. In this case, the profiled sheets can be in particular L-shaped in form. It has been shown that the above-described features further contribute to the fact that a welding distortion present in the region of the connection lines is as far as possible completely eliminated, with the result that the finished hollow profile is as far as possible distortion-free.

In one embodiment, one of the profiled sheets can have a subportion which is defined by a bending axis, forms an underside of the carrier profile and whose width is less than a maximum cross-sectional width of the hollow profile. This can be achieved in particular by a suitable choice of the bending axes and bending angles, with the result that the cross section of the hollow profile increases upwards starting from the underside. Since the installation space is often restricted particularly in the lower region of the carrier profile, it is possible by means of the aforementioned cross-sectional widening for the installation space existing further above to be better utilized and for the stability of the carrier profile to be increased.

The hollow profile can have a cross-sectional width which lies between 10 cm and 45 cm and preferably between 10 cm and 16 cm. A cross-sectional height of the hollow profile can lie in a range between 20 and 90 cm, preferably between 20 cm and 32 cm.

Furthermore, there can be provision that, as viewed in cross section, the profiled sheet comprises an overhang which projects beyond the connection line and whose extent is preferably between 0.5 cm and 5 cm, further preferably between 1 cm and 3 cm. By virtue of the overhang, the production of the hollow profile is simplified particularly when using a welded connection and a secure connection which is continuous over the longitudinal extent is ensured. In particular, the guidance of the welding torch is facilitated and the weld seam can, for example, be configured as a filament seam or HY seam in a simple manner. Moreover, force introduction points (for example due to the articulation of struts) can be realized in a simpler manner in the region of the overhang.

The invention further relates to a frame for carrying a concrete-distribution boom, comprising a carrier profile which has at least one force-absorption region for absorbing a flow of force exerted by the concrete-distribution boom, and a force-dissipation region, which is spaced apart from the force-absorption region in the longitudinal direction, for dissipating the flow of force into the ground. The carrier profile additionally comprises in the force-absorption region an upwardly projecting tab for absorbing and transmitting at least some of the flow of force. There can be provided in particular two force-absorption regions, which are spaced apart in the longitudinal direction of the carrier profile, for absorbing a flow of force exerted by the concrete-distribution boom, wherein the tab can be arranged in a rear one of the force-absorption regions with respect to the longitudinal direction. In the front one of the force-absorption regions, which can be arranged in particular at the front longitudinal end of a carrier profile, it is possible in a customary manner for a boom pedestal for mounting the concrete-distribution boom to be placed on the carrier profile.

The second force-absorption region is spaced apart from the first force-absorption region in the longitudinal direction. The spacing can correspond for example to a length which lies between 10% and 90%, preferably between 25% and 75%, of the longitudinal extent of the carrier profile. The tab can extend in the longitudinal direction over a length which lies in a range between 3% and 50%, preferably between 5% and 30%, of the longitudinal extent of the carrier profile. The above-described frame can be developed by further features explained within the context of the present description.

The frame can have in particular a boom pedestal which is connected to the tab by means of a connecting strut, wherein the connection is preferably produced by means of a bolt connection.

The tab can furthermore have an upper edge whose orientation with an angular deviation of less than 15°, preferably of less than 10°, further preferably of less than 5°, corresponds to an orientation of the connecting strut. A maximum extent of the tab along a vertical axis can lie in a range between 3 cm and 50 cm, preferably in a range between 5 cm and 45 cm and further preferably in a range between 10 cm and 35 cm. In addition, the extent along the vertical axis can decrease in the direction of the rear end of the carrier profile. The tab can be formed by a sheet metal part which is preferably oriented parallel or substantially parallel to the longitudinal direction of the carrier profile. The tab can also be formed as an integral constituent part of the carrier profile.

In one embodiment, the carrier profile comprises at least two profiled sheets which are each bent along at least one bending axis and are assembled along at least two connection lines to form a hollow profile, wherein the tab is formed as an integral constituent part of one of the profiled sheets.

The present invention further relates to a concrete pump, comprising a frame according to the invention, a concrete-distribution boom connected thereto and a pumping device designed to discharge concrete. The arrangement can be developed by further features described above in conjunction with the frame according to the invention.

The pumping device is preferably mounted on the frame according to the invention. The concrete pump can be a stationary or a mobile concrete pump. In the case of a mobile concrete pump, the frame can be designed to be connected to the chassis of a truck.

The present invention additionally relates to a method for producing a carrier profile comprising the following steps:
providing at least two profiled sheets;
producing at least one fastening hole in at least one of the profiled sheets;
bending the profiled sheets along a bending axis of the respective profiled sheet;
assembling the profiled sheets to form a hollow profile;
connecting the profiled sheets along two connection lines.

The method can be developed by further features described above in conjunction with the frame according to the invention. In particular, the profiled sheets can be connected by means of a joining method, in particular by welding.

Further advantages and refinements of the invention will emerge from the dependent claims, the description and the appended drawings.

It will be understood that the features mentioned above and those still to be explained below can be used not only in the respectively specified combination, but also in other combinations or isolation without departing from the scope of the present invention.

### BRIEF DESCRIPTION OF THE DRAWINGS

The invention is illustrated on the basis of an exemplary embodiment in the drawings and described in detail below with reference to the drawings.

FIG. 1 shows a three-dimensional side view of a frame according to the invention,

FIG. 2 shows a three-dimensional side view of a carrier profile used in the embodiment of FIG. 1,

FIG. 3 shows a cross-sectional view of the carrier profile of FIG. 2,

FIG. 4 shows a three-dimensional side view of a further embodiment of a frame according to the invention, and

FIG. 5 shows a three-dimensional side view of a carrier profile used in the embodiment of FIG. 4.

### DETAILED DESCRIPTION

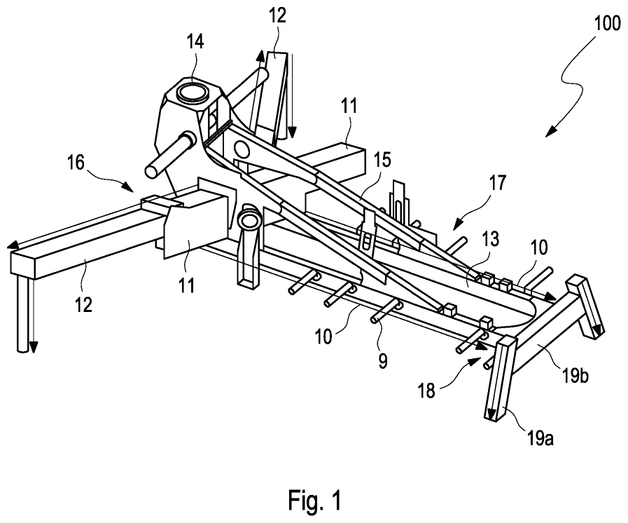

FIG. 1 shows a three-dimensional side view of a frame 100 according to the invention. The frame 100 comprises two carrier profiles 13, which run along its longitudinal direction and are oriented parallel to one another, and a boom pedestal 14 connected to the carrier profiles 13. In a manner which is known in principle, a concrete-distribution boom (not shown in the figure) can be connected to the boom pedestal 14 by means of a rotatable bearing. Also connected to the boom pedestal 14 are support leg boxes 11 in which there are mounted support legs 12 which can be extended and retracted. In the present case, the support leg boxes 11 also lie on the carrier profiles 13.

The boom pedestal 14 is, on the one hand, connected to first connection regions 16 positioned at the front ends of the carrier profiles 13. On the other hand, the boom pedestal 14 is connected, via connecting struts 15 designed as corner profiles, to second connection regions 17 spaced apart in the longitudinal direction of the carrier profiles 13. The two connection regions 16, 17 represent force-absorption regions within the sense of the present invention.

A force-dissipation region 18 is situated at the rear end of the carrier profiles 13 (on the right in FIG. 1). In this force-dissipation region, the carrier profiles 13 are connected to a supporting system which comprises a crossmember 19b and two standing legs 19a. The two force-absorption regions 16, 17 are spaced apart from the force-dissipation region 18 in the longitudinal direction of the carrier profiles 13 such that a flow of force introduced via the force-absorption regions 16, 17 is channeled in the longitudinal direction of the profiled carrier 13 to the force-dissipation region 18 arranged at the rear end. The flow of force is illustrated by the arrows 10. Transverse rods 9 are also connected to the carrier profiles 13. The connection between the transverse rods 9 and the carrier profiles 13 is achieved by means of fastening openings (not visible in FIG. 1) present in the carrier profiles 13.

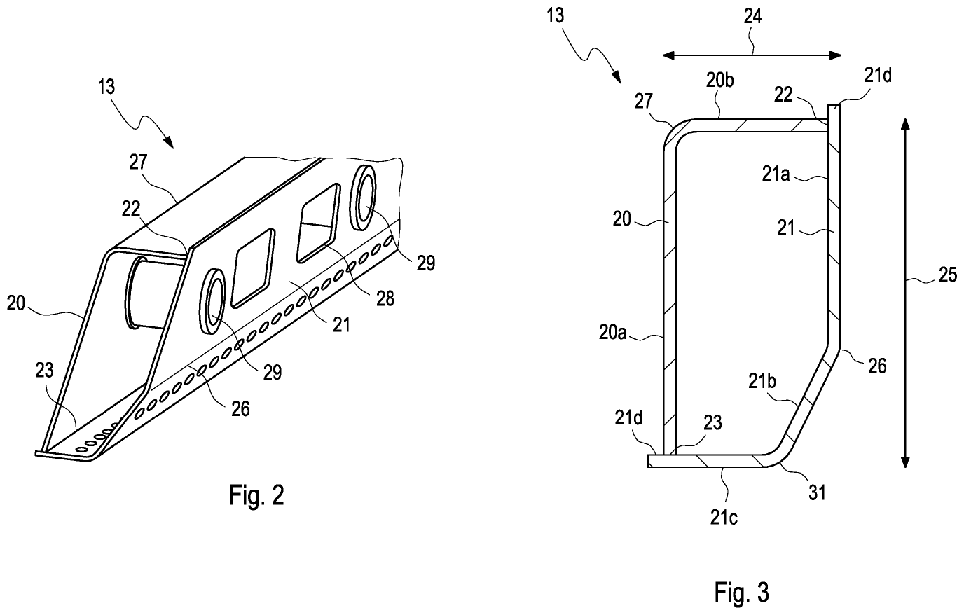

FIG. 2 shows a three-dimensional side view of a part of a carrier profile 13 used in the embodiment of FIG. 1. FIG. 3 shows a cross-sectional view of this carrier profile 13. It can be seen in the views of FIGS. 2 and 3 that the carrier profile 13 comprises two profiled sheets 20, 21 which are assembled to form a hollow profile by being welded to one another along two connection lines 22, 23. This results in a hollow profile having a cross-sectional width 24 of approximately 14 cm and a cross-sectional height 25 of approximately 28 cm. The profiled sheet 21 has overhangs of approximately 2 cm which project beyond the connection lines 22, 23 and which do not count as part of the cross-sectional width 24 or cross-sectional height 25.

The profiled sheet 20 is bent through approximately 90° about a bending axis 27 such that the profiled sheet 20 has two subportions 20a and 20b which are separated from one another by the bending axis 27 and which are at a 90° angle to one another. The profiled sheet 21 is bent through in each case approximately 45° about two bending axes 26, 31 such that it has three subportions 21a, 21b and 21c separated from one another by the bending axes 26, 31. The portions 21a and 21c of the profiled sheet 21 that are each situated at the edge and the portions 20a and 20b of the profiled sheet 20 are at an angle of approximately 90° to one another. In addition, the connection lines 22, 23 lie diagonally opposite one another in an imaginary rectangle formed by the cross-sectional width 24 and the cross-sectional height 25.

It has been shown that a reliable and stable welded connection can be produced with profiled sheets which are perpendicular to one another and when using the aforementioned overhang. In addition, component distortion occurring as a result of heat during welding can be virtually completely avoided owing to the symmetrical arrangement of the connection lines, with the result that no subsequent straightening of the carrier profile 13 is necessary.

The subportion 21c of the profiled sheet 21, which forms an underside of the carrier profile 13, has a width which is less than the maximum cross-sectional width 24 of the carrier profile 13. This means that the carrier profile 13 requires less installation space in the lower region. Through the choice of the bending axes 26, 31, the cross section of the carrier profile increases from the underside in the direction of the upper side until it reaches the total maximum cross-sectional width 24 at the height of the bending axis 26. By means of this cross-sectional increase, it is possible that, in the upper region of the carrier profile, the often less restricted installation space present there can be better utilized and the stability of the carrier profile 13 thus increased.

By means of the above-described embodiment of the profiled sheet 21 with three subportions 21a, 21b, 21c at an angle to one another, despite a large cross section in the upper region of the carrier profile a clearance, for example for chassis parts (such as protruding spring brackets) or wing holders, can be made possible in the lower region, with good accessibility also being ensured in the event of servicing. In addition, by means of the oblique subportion 21b which is angled by approximately 45° with respect to the subportions 21a and 21c, by comparison with other types of cutouts (such as, for example, a cutout angled by 90°), a harmonious flow of force with respect to the cross-sectional values (area moment of inertia, bending, torsion and shear flow) is made possible while simultaneously making the greatest possible use of the installation space.

FIG. 2 additionally shows fastening openings 29 arranged in the profiled sheet 21 and access openings 28 arranged adjacent to the fastening openings 29. Into the fastening openings can be inserted attachment parts, such as, for example, the transverse rods 9 which are shown in FIG. 1 and which are absent in FIG. 2 for the sake of clarity. By virtue of the fastening openings 29, no outlay is necessary for producing a welded connection between an attachment part and the carrier profile. By means of the fastening openings, attachment parts can be screwed to the carrier profile 13 in a simple manner and, if required, can be removed again or transferred.

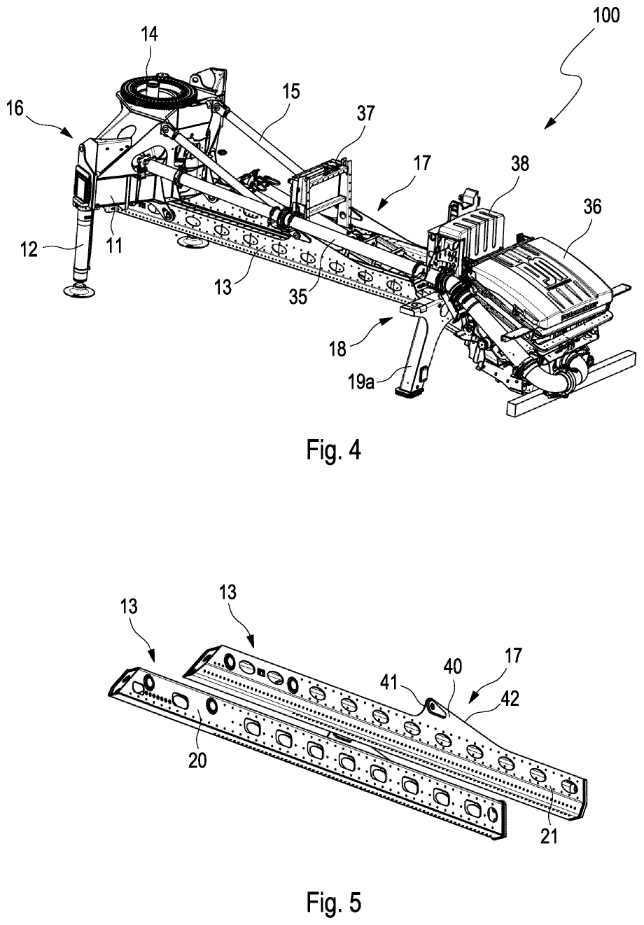

FIG. 4 shows a three-dimensional side view of a further embodiment of a frame 100 according to the invention. FIG. 5 shows a three-dimensional side view of the carrier profiles 13 used in the embodiment of FIG. 4. Those elements which are present identically or similarly in the embodiment of FIGS. 1 to 3 are provided with the same reference signs in FIGS. 4 and 5. By contrast with FIG. 1, FIG. 4 also illustrates a concrete-supply container 36, a concrete line 35 connected thereto and boom-bearing pedestals 37, 38 arranged on the frame 100.

Moreover, the embodiment of FIGS. 4 and 5 differs in particular with respect to the connecting struts 15 and the connection thereof to the carrier profiles 13 in the force introduction region 17. In the embodiment of FIG. 4, the connecting struts 15 take the form of round struts which are connected to the carrier profile 13 via a bolt connection.

For this purpose, the profiled sheet 21 has a tab 40 which projects upwardly beyond the cross-sectional height of the carrier profile 13 by approximately 20 cm and is provided with a through-hole 41 for producing the bolt connection. The tab 40 is an integral constituent part of the profiled sheet 21 such that a flow of force introduced via the connecting struts 15 is introduced directly into the profiled sheet 21 and thus into the carrier profile 13. To allow a particularly good flow of force, the tab 40 has an upper edge 42 whose orientation corresponds approximately to an orientation of the connecting struts 15, with an angle deviation of orientations being preferably less than 5°. The extent of the tab 40 along a vertical axis is accordingly greatest in the region of the bolt connection and decreases in the direction of the rear end of the profile carrier 13.

1. A frame (100) for carrying a concrete-distribution boom, comprising a carrier profile (13) which has at least one force-absorption region (16, 17) for absorbing a flow of force exerted by the concrete-distribution boom, and a force-dissipation region (18), which is spaced apart in the longitudinal direction of the carrier profile (13) for dissipating the flow of force into the ground, wherein the carrier profile (13) comprises at least two profiled sheets (20, 21) which are each bent along at least one bending axis (26, 27, 31) and are assembled along at least two connection lines (22, 23) to form a hollow profile.

2. The frame of claim 1, wherein the profiled sheet (20, 21) has a fastening opening (29) for fixing an attachment part to the carrier profile (13).

3. The frame of claim 2, wherein the fastening opening (29) forms a passage to an inner region of the hollow profile.

4. The frame of claim 2, wherein the profiled sheet (20, 21) has an access opening (28) arranged adjacent to the fastening opening (29), wherein preferably the fastening opening has an area of more than 0.3 cm² and/or the access opening has an area of more than 100 cm².

5. The frame of claim 1, wherein the connection lines (22, 23) and/or the bending axes (26, 27, 31) are oriented parallel to the longitudinal direction of the carrier profile (13).

6. The frame of claim 1, wherein the profiled sheets (20, 21) are joined to one another and preferably welded to one another along the connection lines (22, 23) to form the hollow profile.

7. The frame of claim 1, wherein the hollow profile is composed of two profiled sheets (20, 21).

8. The frame of claim 7, wherein, as viewed in cross section, the profiled sheets (20, 21) are subdivided by the bending axes (26, 27, 31) into subportions (20a, 20b, 21a, 21b, 21c), wherein outside subportions (20a, 20b, 21a, 21c) of a profiled sheet (20, 21) assume an angle with one another of between 45° and 135°, preferably between 75° and 105°, further preferably between 85° and 95° and particularly preferably an angle of substantially 90°.

9. The frame of claim 7, wherein, as viewed in cross section, the profiled sheets (20, 21) are subdivided by the bending axes (26, 27, 31) into subportions (20a, 20b, 21a, 21b, 21c), wherein, in the region of the connection line (22, 23), an outside profiled sheet portion (20a, 20b) of one of the profiled sheets (20) assumes an angle with an adjoining outside profiled sheet portion (21a, 21c) of the other of the profiled sheets (21) of between 45° and 135°, preferably between 75° and 105°, further preferably between 85° and 95° and particularly preferably an angle of substantially 90°.

10. The frame as claimed of claim 7, in which the hollow profile has a maximum cross-sectional width (24) and a maximum cross-sectional height (25), wherein the connection lines (22, 23) are diagonally opposite one another in an imaginary rectangle formed by the cross-sectional width (24) and the cross-sectional height (25).

11. The frame of claim 1, wherein one of the profiled sheets (21) has a subportion (21c) which is defined by a bending axis (31), forms an underside of the carrier profile (13) and whose width is less than a maximum cross-sectional width (24) of the hollow profile.

12. The frame of claim 1, which comprises at least one of the further features:
the hollow profile has a cross-sectional width (24) between 10 cm and 45 cm, preferably between 10 cm and 16 cm;
the hollow profile has a cross-sectional height (25) between 20 cm and 90 cm, preferably between 20 cm and 32 cm;
the profiled sheet (20, 21) comprises an overhang (21d) which projects beyond the connection line (22, 23) and whose extent is preferably between 0.5 cm and 5 cm, further preferably between 1 cm and 3 cm;
the frame has a boom pedestal (14) arranged in the force-absorption region (16, 17) for connecting to the concrete-distribution boom;
the frame has a supporting system (19a, 19b) which is connected to the carrier profile in the force-dissipation region and which is designed to introduce the forces transmitted by the carrier profile into the ground.

13. The frame (100), of claim 1, which is designed to carry a concrete-distribution boom, comprising a carrier profile (13) which has at least one force-absorption region (16, 17) for absorbing a flow of force exerted by the concrete-distribution boom, and a force-dissipation region (18), which is spaced apart from the force-absorption region (16, 17) in the longitudinal direction, for dissipating the flow of force into the ground, wherein the carrier profile (13) has in the force-absorption region (17) an upwardly projecting tab (40) for absorbing and transmitting at least some of the flow of force.

14. The frame of claim 13, which comprises at least one of the further features:
the carrier profile (13) has at least two force-absorption regions (16, 17) which are spaced apart from one another in the longitudinal direction of the carrier profile (13), wherein the tab (40) is arranged in a rear one of the force-absorption regions (17) with respect to the longitudinal direction;
the frame comprises a boom pedestal (14) which is connected to the tab (40) by means of a connecting strut (15);
the connection between the connecting strut (15) and the tab (40) is produced by means of a bolt connection;
the tab (40) comprises an upper edge (42) whose orientation with an angular deviation of less than 15° corresponds to an orientation of the connecting strut (15);
an extent of the tab along a vertical axis preferably decreases in the direction of the rear end of the carrier profile (13);
the tab is formed by a sheet metal part which is oriented substantially parallel to the longitudinal direction of the carrier profile (13);
the carrier profile (13) comprises at least two profiled sheets (20, 21) which are each bent along at least one bending axis (26, 27, 31) and are assembled along at least two connection lines (22, 23) to form a hollow profile, wherein the tab (40) is designed as an integral constituent part of one of the profiled sheets (20, 21).

15. A concrete pump having a frame of claim 1, comprising a concrete pumping device and a concrete-distribution boom which are connected to the frame in the force-absorption region (16, 17).

16. A method for producing a carrier profile, comprising the following steps:
providing at least two profiled sheets,
producing at least one fastening hole in at least one of the profiled sheets,
bending the profiled sheets along a bending axis of the respective profiled sheet,
assembling the profiled sheets to form a hollow profile,
connecting the profiled sheets along two connection lines.

17. The method of claim 16, wherein the profiled sheets are connected along the connection lines by means of welding, wherein the fastening hole is preferably positioned in such a way that, after the profiled sheets (20, 21) have been assembled, it forms a passage to an inner region of the hollow profile.
